(19) United States
(12) Patent Application Publication
(10) Pub. No.: US 2006/0008648 A1
(43) Pub. Date: Jan. 12, 2006

(54) Polyvinylbutyral interlayers having superior acoustical properties and method of preparing same

(76) Inventors: Stephen J Bennison, Wilmington, DE (US); Donald L Rymer, Little Hocking, OH (US)

Correspondence Address: E I du Pont de Nemours & Company, Legal Patents, Wilmington, DE, 19898, US

(21) Appl. No.: 10/525,704

(22) PCT Filed: Oct. 29, 2003
(86) PCT No.: PCT/US03/34736

§ 371 Date: Feb. 18, 2005

Related U.S. Application Data
(60) Provisional application No. 60/421,945, filed on Oct. 29, 2002.

(51) Int. Cl. B32B 17/06; B32B 9/04

(52) U.S. Cl. 428/411.1; 428/426

(57) ABSTRACT

The present invention is a PVB interlayer that is plasticized with a single plasticizer and has sound-damping properties. Interlayers of the present invention when used in glass laminates can provide sufficient strength for use as safety glass laminates.

This application claims the benefit of U.S. Provisional Application No. 60/421,945, filed Oct. 29, 2002.

### BACKGROUND OF THE INVENTION

1. Field of the Invention

The present invention relates to interlayers having sound damping properties that make them useful in sound insulating devices or articles. This invention particularly relates to polyvinyl butyral interlayers having sound damping properties useful in glass laminates for noise reduction.

2. Discussion of the Related Art

Plasticized polyvinyl butyral (PVB) sheet is used in the manufacture of transparent laminate structures such as, for example: windshields for vehicles including automobiles, motorcycles, boats and airplanes, windows in buildings such as office buildings, apartment buildings, houses, and/or commercial buildings, for example.

In modern vehicles—particularly in trains, planes and automobiles—passenger comfort has become an important selling point in commercial transactions involving same. One important feature in a modern vehicle is the ability to minimize noise that originates from outside of the passenger compartment of the vehicle. Automobiles are particularly targeted for improving the acoustic quality of the passenger's ride. Noises coming from the engine compartment, from the sound of tires rolling across a road or the ground, and wind noise created as a car moves at rapid speed through air are all contributors to the noise generated as a car is used as it was intended.

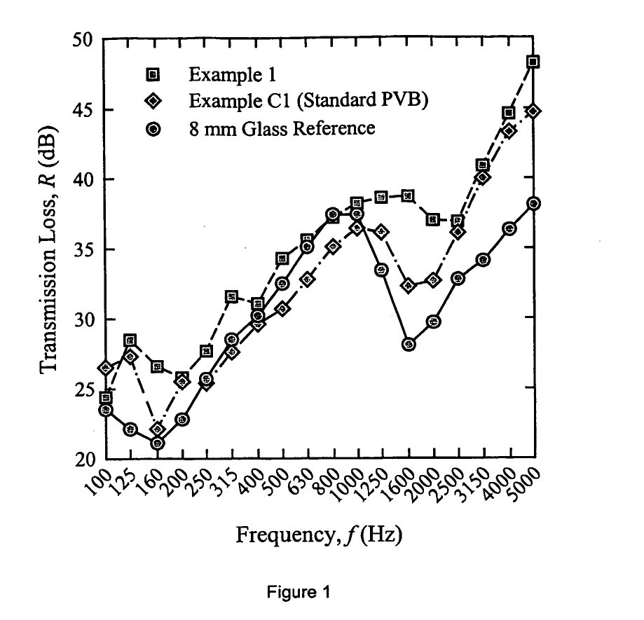

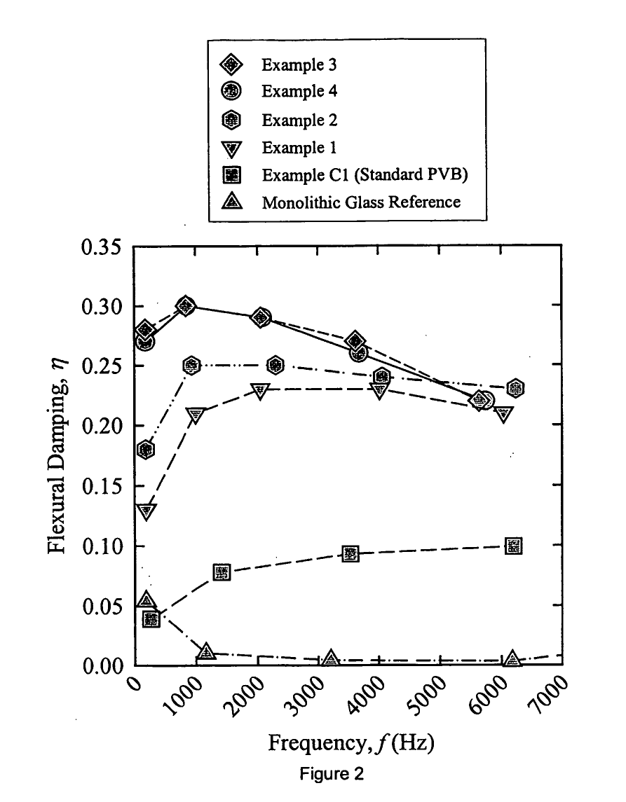

Various improvements and modifications have been made to cars in order to improve the quietness of a passenger's travel, including new tire designs and polymeric noise insulation, which acts to dampen sound waves penetrating the vehicle passenger compartment from the outside. One major source of noise, however, is sound that passes through the windows of a vehicle, the windows typically being good conductors of sound waves especially at critical sound frequencies. Moreover, sound reduction in office and other buildings from noise emanating from outside of the building can be desirable in settings where outside noises can reach the level of distraction inside of a building. FIG. 1 shows the sound transmission loss properties of a monolithic glass plate measured following ISO 140 test protocol. The well-recognized drop in transmission loss properties at a critical frequency, known as a coincidence dip, is particularly detrimental to the sound insulation capabilities of glass. It is known that such a dip may be mitigated by making a laminate structure in which the polymer interlayer is soft enough to decouple vibrations of the two component glass plies and dampen vibrations effectively at frequencies at and around the coincidence dip frequency [“Noise and Vibration Control Engineering: Principles and Applications” by Leo L. Beranek (Editor), István L. Vér (Editor) 2nd edition (August 1992)]. Also plotted are the transmission loss properties of a conventional commercial PVB-glass laminate showing some improvement in the transmission loss in the coincidence dip region. FIG. 2 shows the associated flexural damping characteristics of monolithic and laminated glass made with conventional PVB. Flexural damping was measured using ISO PDPAS 16940. A conventional PVB interlayer significantly increases the damping properties of the laminate, thus helping mitigate the coincidence dip. Such damping also helps reduce noise generated through the windshield that originates from structural vibrations in the main body of the vehicle. Various patents attempt to address the problem of noise reduction in vehicles and/or in buildings. U.S. Pat. No. 5,368,917 and U.S. Pat. No. 5,478,615 describe acoustic laminated glazings for vehicles comprising conventional polyvinyl butyral (PVB). The sound damping properties of the PVB sound-damping laminate described therein is highly temperature dependent. U.S. Pat. No. 6,132,882 describes a sound-damping laminate comprising a vibration-damping layer such as a polyacrylate, at least one flexible plastic layer such as PVB, and a rigid glass or plastic sheet. U.S. Pat. No. 5,773,102 describes a soundproofing laminated glass pane wherein a high-performance acoustic film is combined with at least one film having ordinary acoustic performance, such as PVB. U.S. Pat. No. 5,190,826 describes interlayers for use in sound-insulating laminated glass wherein two types of polyvinyl acetal films are combined, or an interlayer which combines the two types of polyvinyl acetal films for the sound-insulating material. One polyvinyl acetal is formed from an aldehyde with from 6 to 10 carbons, the other is formed from an aldehyde with from 1 to 4 carbons. U.S. Pat. No. 6,074,732 describes a soundproofing laminated window made of two glass sheets between which are polymer layers in the order of PVB/PET/acrylate/PET/PVB. The PVB layers are standard PVB. WO 01/19747 A1 describes glass laminates wherein PVB is softened (plasticized) with 20 to 50 wt % of a two-component plasticizer mixture comprising 30 to 70 wt % of a polyalkylene glycol as one of the components. This latter application describes a PVB that is softened with a single component plasticizer as unsuitable for sound damping applications due to processing difficulties. It would be desirable to have a glass laminate for a window, which has the benefits associated with standard safety glass and also has the benefit of damping outside sounds. It would also be desirable to construct such a laminate using only one type of interlayer material, as in a standard safety glass, using PVB interlayer that has been plasticized with a single plasticizer.

### SUMMARY OF THE INVENTION

In one aspect, the present invention is an interlayer having sound-damping properties that is useful for preparing acoustic laminates, the interlayer comprising or consisting essentially of: (i) polyvinyl butyral (PVB) having a hydroxyl number in the range of from about 17 to about 23 and (ii) a one-component plasticizer tetraethylene glycol 2-heptanoate as the single plasticizer in an amount in the range of from about 40 to about 50 pph parts.

In another aspect, the present invention is a glass laminate having sound-damping properties comprising or consisting essentially of: a homogeneous interlayer of polyvinyl butyral positioned between two sheets of glass, wherein the PVB has a hydroxyl number in the range of from about 17 to about 23 and comprises a single plasticizer in an amount of from about 40 to about 50 pph parts.

In still another aspect, the present invention is an article having sound-damping properties comprising: a glass laminate having sound-damping properties wherein the laminate comprises or consists essentially of a homogeneous interlayer of polyvinyl butyral positioned between two sheets of glass, wherein the PVB has a hydroxyl number in the range of from about 17 to about 23 and comprises a single plasticizer in an amount of from about 40 to about 50 pph parts.

### DETAILED DESCRIPTION OF THE INVENTION

In one embodiment, the present invention is a polyvinyl butyral (PVB) interlayer material having sound-damping properties. A sound-damping PVB interlayer of the present invention has sound-damping properties in the frequency range of from about 10 Hz to about 10,000 Hz at a temperature in the range of from about 10° C. to about 30° C. Preferably the interlayer provides sound-damping properties in the range of from about 1000 Hz to about 5000 Hz at a temperature in the range of from about 10° C. to about 30° C. More preferably, the interlayer provides the above sound-damping properties at a temperature in the range of from about 15° C. to about 25° C.

The PVB of the present invention is plasticized with a singular (one-component) plasticizer in such an amount that a PVB interlayer that is soft, compliant and viscoelastic is obtained. To obtain a PVB interlayer of the present invention, PVB can be plasticized with from about 40 parts per hundred parts (pph) to about 50 pph. Preferably, the interlayer is plasticized with from about 41 pph to about 49 pph, more preferably from about 42 pph to about 49 pph, and most preferably from about 44 to about 47 pph. The amount of plasticizer required to make the interlayer compliant and suitable for use herein can depend on the other factors, in addition to the amount of plasticizer used.

A suitable plasticizer for use in the present invention is any plasticizer that is conventional for use with PVB. For example, conventional plasticizers useful in the preparation of plasticized PVB include such plasticizers as: diesters of polyethylene glycol such as triethylene glycol di(2-ethylhexanoate) (3GO), tetraethylene glycol di heptanoate (4G7), triethyleneglycol di(2-ethylbutyrate), and di-hexyl adipate. Preferably, the plasticizer is one that is compatible (that is, forms a single phase with the interlayer) in the amounts described hereinabove with PVB having a hydroxyl number (OH number) of from about 17 to about 23. Preferably the PVB of the present invention has an OH number of from about 18 to about 21, more preferably the OH number is from about 18 to about 19.5, and most preferably from about 18 to about 19. A particularly preferred plasticizer for use herein is one that is compatible with the PVB in any of the preferred ranges.

In the practice of the present invention, a single plasticizer is used to plasticize the PVB sufficiently to produce the sound-damping properties in the PVB interlayer. In a particularly preferred embodiment, the present invention is a glass laminate having sound-damping properties comprising a PVB interlayer having a hydroxyl number of 18.5 and plasticized with a single plasticizer, which is present in an amount of from about 40 pph to 50 pph.

Whereas heretofore PVB has been used only in acoustic glass laminates having multiple interlayers, or in laminates having a single interlayer wherein PVB is plasticized using a combination of plasticizers, the Applicants have discovered a PVB interlayer having sound-damping capability and also sufficient adhesion and strength to provide a single homogeneous interlayer glass laminate that is useful as a conventional safety glass and also as a sound-damping glass laminate. Furthermore, the interlayer claimed can also be processed with glass to form a laminate using established laminate manufacturing practices. By “single homogeneous interlayer” it is meant that the interlayer has the same composition from the inner surface of one sheet of glass to the inner surface of the second sheet of glass, whether the interlayer is one sheet of PVB or multiple layers of PVB (that is, at least one layer of PVB). By “the same composition” it is meant that the composition of each of the at least one PVB interlayers between the glass sheets is of a composition defined by the present invention. In other words, it is contemplated that a “single homogeneous interlayer” of the present invention can be one sheet of PVB interlayer of the present invention or multiple layers of PVB, provided that each interlayer sheet is PVB that has the composition as it is defined within the scope of the present invention.

To provide the properties required for the expected performance of conventional PVB, it can be required that the sound-damping PVB interlayer be used as a thicker sheet than conventional PVB interlayer sheets. Sound-damping PVB of the present invention can be used at thicknesses in the range of from about 15 mils to about 70 mils. Preferably, the thickness of the interlayer sheet is from about 20 mils to about 60 mils, and more preferably from about 30 mils to about 45 mils. The desired thickness can be obtained by using one PVB sheet having the desired thickness, or alternatively the interlayer can be multiple sheets of PVB of the present invention having individual thicknesses such that when they are stacked together they provide the desired total thickness of the interlayer.

The PVB interlayer of the present invention can be used as an interlayer with other transparent, rigid materials which are conventionally substituted for glass to provide transparent laminates, and which have sufficient adhesion to PVB to provide a laminate having a stable structure with respect to the conventional tests and measurements. For example, polycarbonate, polyester, and polyacrylic acids or polyacrylic esters can be useful substitutes for glass in the practice of the present invention.

Acoustic laminates of the present invention can be useful in automobiles, trains, airplanes, or other motor vehicles. For example, the laminates of the present invention can be used as automobile windshields, back lites and side lites, as windows in trains and airplanes, and as glass partitions in limousines or other luxury vehicles. Acoustic laminates of the present invention can also be suitable for use in architectural applications. For example, acoustic laminates of the present invention can be used as windows in buildings, as doors, glass partitions, balustrades, glass floors, or other applications where the sound-damping is desirable in addition to the aesthetic characteristics that transparent laminates provide, and also wherein the structural integrity of safety glass is desirable.

### EXAMPLES

The following Examples and comparative examples are presented to further illustrate the present invention. The Examples are not intended to limit the scope of the invention in any manner, nor should they be used to define the claims or specification in any manner that is inconsistent with the invention and/or as described herein:

Analytical tests for Hydroxyl number and acoustical measurements were performed for each of the samples according to the methods below: Hydroxyl number: ASTM D 1396-92

### Example 1

Poly(vinyl butyral) sheet was prepared as follows: at 90° C., a mixture comprising 32 parts weight of poly(vinyl alcohol) (PVA) of average degree of polymerization 618 and 68 parts by weight of PVA of average degree of polymerization 1005 from commercially available PVA was dissolved in 615 parts by weight of demineralized water. To this solution was added 1.3 parts by weight of 88% para-toluene sulfonic acid and enough sulfuric acid to bring the dissolved PVA solution to a pH of 2. Using the procedure described in U.S. Pat. No. 3,153,009, enough n-butyraldehyde was added to achieve a hydroxyl number of 18.5 and 0.33% DOSS (sodium di-octylsulfosuccinate) based on dry PVA weight and the PVA were charged into the reaction vessel maintained at 90° C. After a one hour hold time, a slurry was obtained; a surface tension modifier was added to attenuate foam and the slurry was stabilized with sodium hydroxide solution to raise the pH of the mixture to pH 11. The slurry was then washed and cooled with demineralized water. A granular, white PVB resin with a residual hydroxyl number of 18.5 was obtained. The flake was mixed with 4G7 plasticizer containing 4 grams per liter of Tinuvin® P, 1.2 grams Tinuvin® 123, and 8 grams per liter of octylphenol antioxidant and was extruded so that the residence time in the extruder was within 10-25 minutes. The feed rate ratio of the plasticizer to dry flake was 44:100 (wt:wt). An aqueous solution of 3:1 potassium acetate:magnesium acetate was injected during extrusion to deliver a potassium concentration of 50-100 ppm. Melt temperature measured at the slot die was between 190° C. and 215° C. The transmission loss for a 4 mm glass/1 mm acoustic PVB/4 mm glass laminate made with the modified PVB described was measured and is shown in FIG. 1. The flexural damping of laminate beams made with the modified PVB is depicted in FIG. 2.

### Example 2

PVB flake was prepared as in Example 1 except that 0.2 parts by weight of sodium lauryl sulfate was used in the place of DOSS as the surfactant and no other surface modifiers were added. A granular, white PVB resin with a residual hydroxyl of 22.1 was obtained. Using this flake, sheeting was prepared as in Example 1. FIG. 2 shows the resulting flexural damping of laminate beams made with the modified PVB described in this example.

### Example 3

PVB flake was prepared as in Example 1. This flake was mixed with 4G7 Plasticizer containing 4 gms/liter Tinuvin® 326, 4 gms liter Tinuvin® 123, and 8 gms/liter octylphenol and was extruded so that the residence time in the extruder was between 10-25 minutes. The feed ratio of the plasticizer to dry flake was 47:100 (wt:wt). A solution of 3:1 potassium acetate:magnesium acetate was injected during the extrusion to deliver a potassium concentration of 35-100 ppm. Melt temperature measured in the slot die was between 190° C. and 215° C.

### Example 4

PVB resin was prepared as in Example 1 and formulated and extruded as in Example 3, except the feed ratio of the plasticizer to dry flake was 49:100 (wt:wt).

### Comparative Example C1

The flake described in Example 1 was used to prepare sheet as in Example 1 except that 3GO plasticizer was used with the same additives at feed ratio of 3GO plasticizer to dry resin of 37:100. Sound transmission loss characteristics are shown in FIG. 1 and flexural damping characteristics are shown in FIG. 2. These characteristics are denoted as standard PVB in these figures.

What is claimed is:

1. An interlayer having sound-damping properties that is useful for preparing acoustic laminates, the interlayer comprising or consisting essentially of: (i) polyvinyl butyral (PVB) having a hydroxyl number in the range of from about 17 to about 23 and (ii) a single plasticizer in an amount in the range of from about 40 to about 50 parts per hundred (pph).

2. The interlayer of claim 1 wherein the PVB has a hydroxyl number in the range of from about 18 to about 21.

3. The interlayer of claim 2 wherein the PVB has a hydroxyl number in the range of from about 18 to about 19.5.

4. The interlayer of claim 3 wherein the plasticizer is selected from plasticizers in the group consisting of: diesters of polyethylene glycol.

5. The interlayer of claim 4 wherein the plasticizer is selected from plasticizers in the group consisting of: triethylene glycol di(2-ethylhexanoate) (3GO), tetraethylene glycol di heptanoate (4G7), triethyleneglycol di(2-ethylbutyrate),and di-hexyl adipate.

6. The interlayer of claim 5 wherein the plasticizer is 3GO.

7. The interlayer of claim 5 wherein the plasticizer is present in an amount of from about 44 pph to about 47 pph.

8. A glass laminate having sound-damping properties comprising or consisting essentially of: a homogeneous interlayer of polyvinyl butyral positioned between two sheets of glass, wherein the PVB has a hydroxyl number in the range of from about 17 to about 23 and comprises a single plasticizer in an amount of from about 40 to about 50 pph parts.

9. The glass laminate of claim 8 wherein the PVB has a hydroxyl number in the range of from about 18 to about 21.

10. The glass laminate of claim 9 wherein the PVB has a hydroxyl number in the range of from about 18 to about 19.5.

11. The glass laminate of claim 8 wherein the plasticizer is selected from plasticizers in the group consisting of: diesters of polyethylene glycol.

12. The glass laminate of claim 11 wherein the plasticizer is selected from plasticizers in the group consisting of: triethylene glycol di(2-ethylhexanoate) (3GO), tetraethylene glycol di heptanoate (4G7), triethyleneglycol di(2-ethylbutyrate),and di-hexyl adipate.

13. The glass laminate of claim 12 wherein the plasticizer is 3GO.

14. The glass laminate of claim 12 wherein the plasticizer is present in an amount of from about 44 pph to about 47 pph.

15. An article comprising a glass laminate having sound-damping properties wherein the laminate comprises or consists essentially of a homogeneous interlayer of polyvinyl butyral positioned between two sheets of glass, wherein the PVB has a hydroxyl number in the range of from about 17 to about 23 and comprises a single plasticizer in an amount of from about 40 to about 50 pph parts.

16. The article of claim 15 wherein the PVB has a hydroxyl number in the range of from about 18 to about 21.

17. The article of claim 16 wherein the PVB has a hydroxyl number in the range of from about 18 to about 19.5.

18. The article of claim 17 wherein the plasticizer is selected from plasticizers in the group consisting of diesters of polyethylene glycol.

19. The article of claim 18 wherein the plasticizer is selected from plasticizers in the group consisting of: triethylene glycol di(2-ethylhexanoate) (3GO), tetraethylene glycol di heptanoate (4G7), triethyleneglycol di(2-ethylbutyrate), and di-hexyl adipate.

20. The article of claim 19 wherein the plasticizer is 3GO.

21. The article of claim 19 wherein the plasticizer is present in an amount of from about 44 pph to about 47 pph.

22. The article of claim 18 wherein the article is a motorized vehicle.

23. The vehicle of claim 22 wherein the vehicle is selected from the group consisting of: an automobile; a train; and a plane.

24. The article of claim 18 wherein the article is a building.

25. The article of claim 24 wherein the glass laminate is a window glazing unit.

26. The article of claim 24 wherein the glass laminate is: a partition, a wall, a floor, or a ceiling.
